(19) United States
(12) Patent Application Publication
(10) Pub. No.: US 2021/0114189 A1
(43) Pub. Date: Apr. 22, 2021

(54) ADJUSTABLE SPANNER WRENCH AND METHOD OF USE

(71) Applicant: Jerald Miller, Wittmann, AZ (US)

(72) Inventor: Jerald Miller, Wittmann, AZ (US)

(21) Appl. No.: 17/074,244

(22) Filed: Oct. 19, 2020

Related U.S. Application Data
(63) Continuation of application No. 29/709,856, filed on Oct. 17, 2019, now Pat. No. D912482.
(60) Provisional application No. 62/916,699, filed on Oct. 17, 2019.

(51) Int. Cl. B25B 23/00; B25G 3/38; B25B 13/50

(52) U.S. Cl. CPC B25B 23/0028; B25B 13/50; B25G 3/38

(57) ABSTRACT

An adjustable spanner wrench having a handle, a spanner head, a coil spring, a sliding pin, a shoulder bolt and a handle. The adjustable handle spanner wrench allows the handle of the wrench to easily change the relationship of the handle to a protrusion on the spanner portion of the wrench. This allows the wrench to engage a notch or hole on an adjustment ring easily and have a full sweep of the wrench between obstructions surrounding a coilover shock.

### RELATED APPLICATION(S)

This invention claims priority to U.S. provisional patent application Ser. No. 62/916,699, filed Oct. 17, 2019 entitled “Adjustable Spanner Wrench,” and claims priority to U.S. design patent application Ser. No. 29/709,856, filed Oct. 17, 2019 and entitled “Spanner Wrench,” both of which are included entirely herein by reference.

### BACKGROUND OF THE INVENTION

### Technical Field

This invention relates to an adjustable spanner wrench and a method of using an adjustable spanner wrench.

### State of the Art

Background and statement of the problem.

A vehicle coilover shock absorber is a combination of a shock absorber surrounded by a coil spring. The shock body has a series of threads around the body of the shock which an adjustment ring is threaded upon. This allows the spring to be raised or lowered on the shock absorber which in turn will raise or lower the vehicle that the coilover shock is fixed upon. The adjustment ring has a series of notches or holes to allow a specialized spanner wrench to engage these notches or holes to rotate the adjustment ring. The standard in the industry is a fixed handle spanner wrench in various configurations with a protrusion or pin which engages the notch or hole in the adjustment ring.

Because of many obstructions around a coilover shock the ongoing problem with a fixed handle wrench is that it limits the access and sweep in several directions when attempting to turn the adjustment ring because the pin or protrusion is fixed in relation to the handle of the spanner wrench and the handle of the wrench will interfere with an obstruction. This allows only a limited sweep or no access to a notch or hole to engage the spanner wrench in the adjustment ring.

Accordingly, what is needed is an adjustable handle spanner wrench to solve access and limited sweep problems.

### DISCLOSURE OF THE INVENTION

The disclosed invention relates to an adjustable spanner wrench. Disclosed is a an adjustable spanner wrench apparatus comprising: a handle having a bore extending down its length to accept a spring and a sliding pin; and a spanner head having a spanner hole and a series of notches at its base portion, wherein the spanner head is attached to the handle with pivot pin extending through a pin receiving hole in an upper portion of the handle and through the spanner hole of the spanner head. The sliding pin may be prevented from turning in the bore by a shoulder bolt. The shoulder bolt may be threaded into the sliding pin through a slot machined lengthwise through the handle. The spanner head may have a semi-circle configuration and a protrusion. The shoulder bolt and the sliding pin may retract within the bore of the handle, allowing the spanner head to swivel.

Disclosed is a method of using an adjustable spanner wrench for adjusting a coilover shock comprising: engaging notches on an adjustment ring of a coilover shock with the adjustable spanner wrench, wherein the adjustable spanner wrench comprises a handle having a bore extending down its length to accept a spring and a sliding pin; and a spanner head having a spanner hole and a series of notches at its base portion, wherein the spanner head is attached to the handle with pivot pin extending through a pin receiving hole in an upper portion of the handle and through the spanner hole of the spanner head; and moving the handle to three different positions allowing full sweep of the adjustment ring on the coilover shock. The sliding pin may be prevented from turning in the bore by a shoulder bolt. The shoulder bolt may be threaded into the sliding pin through a slot machined lengthwise through the handle. The spanner head may have a semi-circle configuration and a protrusion. The shoulder bolt and the sliding pin may retract within the bore of the handle, allowing the spanner head to swivel.

The foregoing and other features and advantages of the invention will be apparent to those of ordinary skill in the art from the following more particular description of the invention and the accompanying drawings.

### BRIEF DESCRIPTION OF THE DRAWINGS

FIG. 1 shows a plane view of adjustable spanner wrench 100 in a first position;

FIG. 2 shows a plane view of adjustable spanner wrench 100 in a second position;

FIG. 3 shows a plane view of adjustable wrench 100 in a third position;

FIG. 4 shows an assembled view in a locked position of handle 10 with spanner head 20; and

FIG. 5 shows an assembled view in an unlocked position of handle 10 with spanner head 20.

### DETAILED DESCRIPTION OF EMBODIMENTS OF THE INVENTION

As discussed above, embodiments of the present invention relate to an adjustable spanner wrench. The adjustable handle spanner wrench allows the handle of the wrench to easily change the relationship of the handle to a protrusion on the spanner portion of the wrench. This allows the wrench to engage a notch or hole on an adjustment ring easily and have a full sweep of the wrench between obstructions surrounding a coilover shock.

The wrench has a handle with three specific orientations that correspond to notches or recesses. A spring-loaded lock mechanism allows the user to disengage a lock member that is biased within the recesses to prevent rotation.

The adjustable handle coilover shock absorber spanner wrench comprises a handle, a spanner head, a coil spring, a sliding pin, at least one shoulder bolt, such an Allen head shoulder bolt, and a handle.

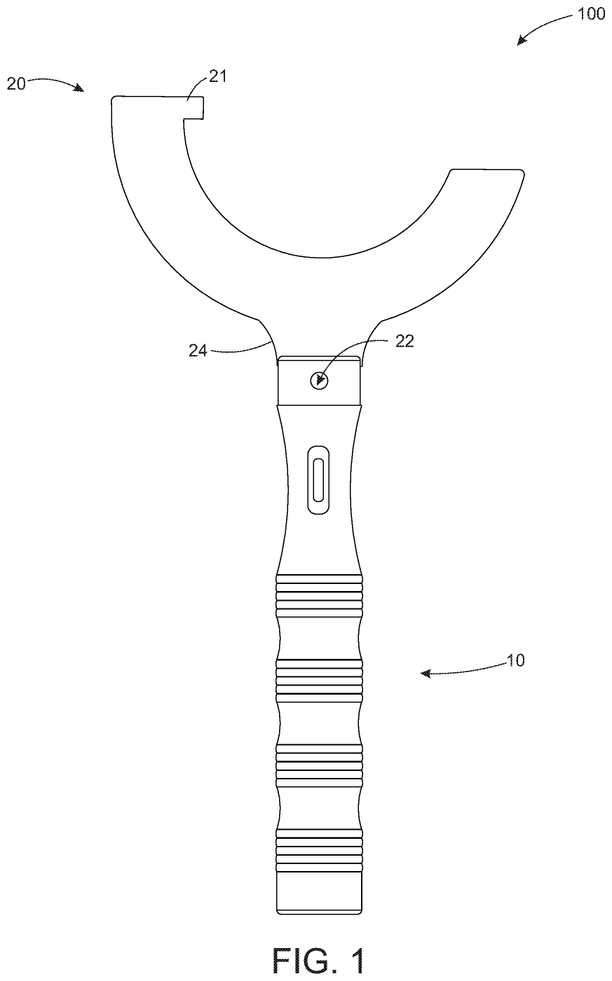

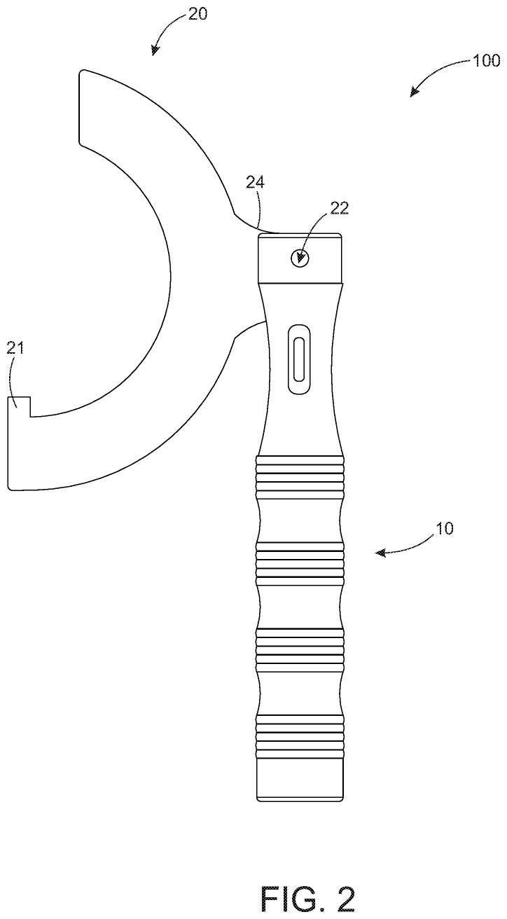

As shown in FIGS. 1 to 5, adjustable spanner wrench 100 comprises handle 10 and spanner head 20, handle 10 having a blind hole or bore 11 extending down its length to accept spring 12 and sliding pin 13. Sliding pin 13 is prevented from turning in bore 11 by a shoulder bolt 14 threaded into sliding pin 13 through slot 15 machined lengthwise through handle 10. Spanner head 20 has a semi-circle configuration and a protrusion 21 that engages a notch or hole in a coilover shock adjustment ring (not shown).

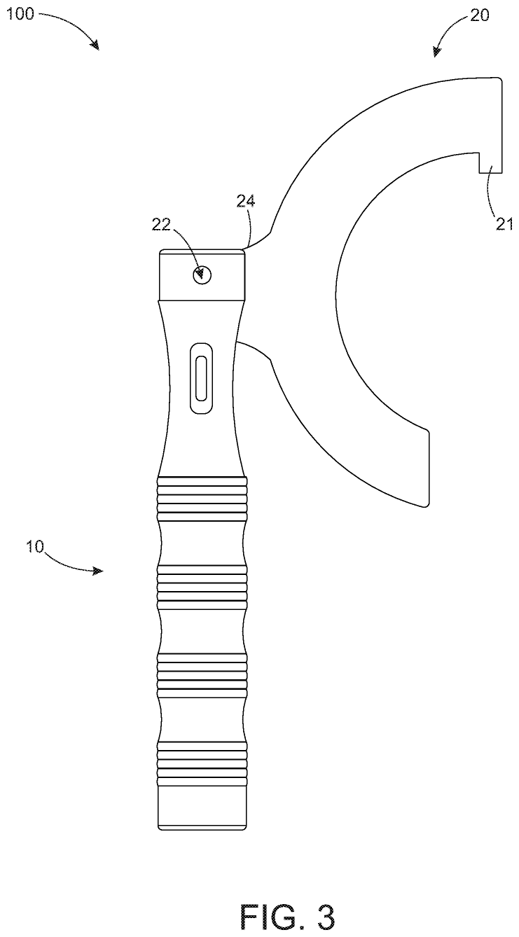

Spanner head 20 has a spanner hole 22 and a series of notches 23 at its base portion 24. Spanner head 20 is attached to handle 10 with pivot pin 30 (see FIG. 3) extending through a pin receiving hole 16 (see FIG. 1) in upper portion 17 of handle 10 and through spanner hole 22 of spanner head 20. Shoulder bolt 14 and sliding pin 13 retracts within bore 11 in handle 10 which allows spanner head 20 to swivel. The shoulder bolt 14 and the sliding pin are retracted within the bore 11 in response to applying force on the shoulder bolt 14 in a direction away from the spanner head 20. This may be performed by a user applying force with is thumb to the shoulder bolt 14, that thereby retracts the shoulder bolt 14 and the sliding pin 13 to disengage the sliding pin 13 from one of notches 23.

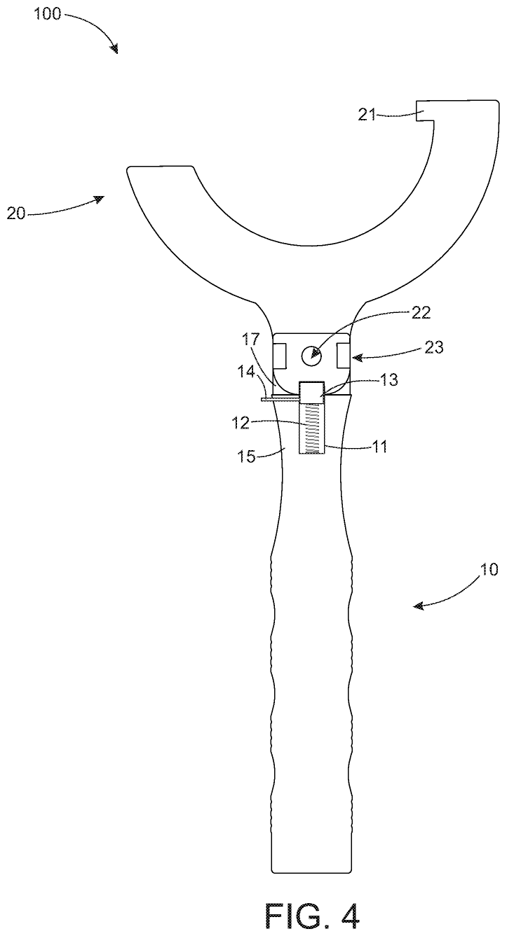

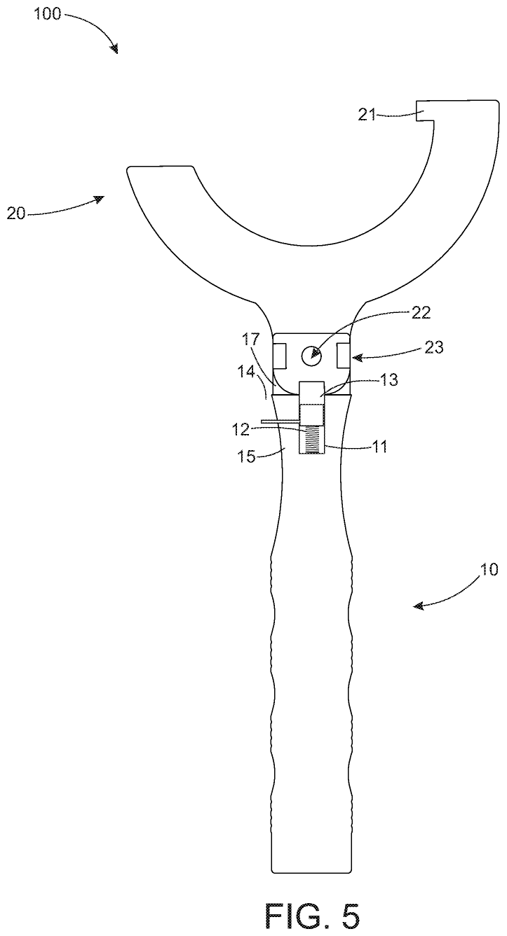

Once spanner head 20 is repositioned to correspond to a different one of notches 23 of spanner head 20, the user releases sliding pin 13 under the influence of coil spring 12 so as to allow sliding pin 13 to engage to one of notches 23. Sliding pin 13 which now engages one of the notches 23 in spanner head 20 is held by the bias exerted on sliding pin 13 by spring 12. The sliding pin 13 can again be disengaged from the selected notch of notches 23 in spanner head 20 by the user pulling back on sliding pin 13 and applying a force on spring 12 with the user's thumb on shoulder bolt 14 which protrudes through handle 10 attached to sliding pin. By engaging any one of three notches 23 in spanner head 20 with sliding pin 13 allows the handle 10 to be in one of three different angles in relation to the spanner head. FIGS. 1-3 show the three different locking positions of adjustable spanner wrench 100. In FIG. 4, sliding pin 13 is engaged in a locked position and in FIG. 5 sliding pin 13 is disengaged in an unlocked position.

A method of for adjusting coilover shocks is also disclosed. Adjustable spanner wrench 100 engages notches on an adjustment ring of the coilover shock. The adjustable spanner wrench according to the invention allows the handle 10 to be moved to three different positions to give the full sweep of the adjustment ring on the coilover shock. The spanner head 20 is easily interchangeable and removeable for working with different styles of coilover shocks.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above.

1. An adjustable spanner wrench apparatus comprising:
a handle having a bore extending down its length to accept a spring and a sliding pin; and
a spanner head having a spanner hole and a series of notches at its base portion, wherein the spanner head is attached to the handle with pivot pin extending through a pin receiving hole in an upper portion of the handle and through the spanner hole of the spanner head.

2. The wrench apparatus of claim 1, wherein the sliding pin is prevented from turning in the bore by a shoulder bolt.

3. The wrench apparatus of claim 2, wherein the shoulder bolt is threaded into the sliding pin through a slot machined lengthwise through the handle.

4. The wrench apparatus of claim 1, wherein the spanner head has a semi-circle configuration and a protrusion.

5. The wrench apparatus of claim 1, wherein the shoulder bolt and the sliding pin retracts within the bore of the handle, allowing the spanner head to swivel.

6. The wrench apparatus of claim 1, wherein the spanner head is removable.

7. A method of using an adjustable spanner wrench for adjusting a coilover shock comprising:
engaging notches on an adjustment ring of a coilover shock with the adjustable spanner wrench, wherein the adjustable spanner wrench comprises a handle having a bore extending down its length to accept a spring and a sliding pin; and
a spanner head having a spanner hole and a series of notches at its base portion, wherein the spanner head is attached to the handle with pivot pin extending through a pin receiving hole in an upper portion of the handle and through the spanner hole of the spanner head; and
moving the handle to three different positions allowing full sweep of the adjustment ring on the coilover shock.

8. The method of claim 7, wherein the sliding pin is prevented from turning in the bore by a shoulder bolt.

9. The method of claim 8, wherein the shoulder bolt is threaded into the sliding pin through a slot machined lengthwise through the handle.

10. The method of claim 7, wherein the spanner head has a semi-circle configuration and a protrusion.

11. The method of claim 7, wherein the shoulder bolt and the sliding pin retracts within the bore of the handle, allowing the spanner head to swivel.

12. The method of claim 7, wherein the spanner head is removable.
